(19) United States
(12) Patent Application Publication
(10) Pub. No.: US 2006/0218585 A1
(43) Pub. Date: Sep. 28, 2006

(54) Edited contents reproducing method and apparatus, and computer-readable storage medium

(75) Inventors: Yasuhiko Isobe, Kawasaki (JP); Hisashi Negishi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/208,779

(22) Filed: Aug. 23, 2005

(30) Foreign Application Priority Data
Mar. 28, 2005 (JP) 2005-092996

(51) Int. Cl. H04N 7/173; G06F 9/00; G06F 3/00; G06F 17/00; G11B 27/00; H04N 5/445; G06F 13/00

(52) U.S. Cl. 725/39; 725/88; 715/758; 715/751; 715/723; 715/731

(57) ABSTRACT

An edited contents reproducing method includes accessing, from a first apparatus storing desired program contents, via a network, editing information indicating edited parts of the desired program contents stored in a second apparatus that is other than the first apparatus, based on user information related to an editor and/or program information, and reproducing, in the first apparatus, the desired program contents in an edited state based on the editing information that is accessed.

### BACKGROUND OF THE INVENTION

1. Field of the Invention

The present invention generally relates to edited contents reproducing methods and apparatuses and computer-readable storage media, and more particularly to an edited contents reproducing method and an edited contents reproducing apparatus for reproducing edited contents such as television programs, and to a computer-readable storage medium that stores a program for causing a computer to operate as such an edited contents reproducing apparatus.

2. Description of the Related Art

In information processing apparatuses such as personal computers, there are those that are installed with an application for realizing functions of recording and editing contents such as television programs. For example, in the case of a television program, a user may use this application to edit the television program by cutting commercial portions, and to record the edited contents. When the edited contents are reproduced, the television program is continuously reproduced in a state where the cut commercial portions are eliminated.

For example, in the case of the edited contents related to the television program in which the commercial portions are cut, it would be useful if other users were able to access the edited contents. If the other users were able to access the edited contents, the other users would not have to perform the troublesome editing operation by themselves.

A Japanese Laid-Open Patent Application No. 7-104960 proposes an apparatus that stores display position information of media data for each track data, and reproduces and displays the media data at a predetermined position of a display unit at the time of the reproduction by referring to the stored display position information corresponding to each track.

On the other hand, a Japanese Laid-Open Patent Application No. 2000-330463 proposes a learning system that searches and reads a teaching material to be transmitted from recorded teaching information, so as to distribute the teaching material to learners, when sending the recorded teaching material to the learners.

However, if the edited contents are exchanged among the users via a network, there was a problem in that the load on the network increases considerably as the amount of data of the contents exchanged via the network increases.

In addition, in order to exchange the edited contents among the users, it is necessary for the user desiring the edited contents to request the edited contents to the user who possesses the edited contents, and the user who possesses the edited contents must send the edited contents to the user desiring the edited contents in response to the request. For this reason, taking into consideration the fact that the user desiring the edited contents must judge which user actually possesses the desired edited contents, there was a problem in that troublesome operations are required at both users, namely, the user desiring the edited contents and the user possessing and providing the desired edited contents.

### SUMMARY OF THE INVENTION

Accordingly, it is a general object of the present invention to provide a novel and useful edited contents reproducing method and apparatus, and computer-readable storage medium, in which the problems described above are suppressed.

Another and more specific object of the present invention is to provide an edited contents reproducing method, an edited contents reproducing apparatus and a computer-readable storage medium, which can reduce the load on a network, and enable desired edited contents to be reproduced by a relatively simple operation.

Still another object of the present invention is to provide an edited contents reproducing method comprising (a) accessing, from a first apparatus storing desired program contents, via a network, editing information indicating edited parts of the desired program contents stored in a second apparatus that is other than the first apparatus, based on user information related to an editor and/or program information; and (b) reproducing, in the first apparatus, the desired program contents in an edited state based on the editing information that is accessed. According to the edited contents reproducing method of the present invention, it is possible to reduce the load on the network, and enable the desired edited contents to be reproduced by a relatively simple operation.

A further object of the present invention is to provide an edited contents reproducing apparatus comprising a storage part configured to store desired program contents; an access part configured to access, via a network, editing information indicating edited parts of the desired program contents stored in an external apparatus, based on user information related to an editor and/or program information; and a reproducing part configured to reproduce the desired program contents in an edited state based on the editing information that is accessed. According to the edited contents reproducing apparatus of the present invention, it is possible to reduce the load on the network, and enable the desired edited contents to be reproduced by a relatively simple operation.

Another object of the present invention is to provide a computer-readable storage medium which stores a program for causing a computer that stores desired program contents in a storage part to access editing data, where the program comprises an accessing procedure causing the computer to access, via a network, editing information indicating edited parts of the desired program contents stored in an external apparatus, based on user information related to an editor and/or program information; and a reproducing procedure causing the computer to reproduce the desired program contents in an edited state based on the editing information that is accessed. According to the computer-readable storage medium of the present invention, it is possible to reduce the load on the network, and enable the desired edited contents to be reproduced by a relatively simple operation.

Other objects and further features of the present invention will be apparent from the following detailed description when read in conjunction with the accompanying drawings.

### BRIEF DESCRIPTION OF THE DRAWINGS

FIG. 1 is a diagram showing a system to which the present invention may be applied;

FIG. 2 is a flow chart for explaining an editing information creating process;

FIG. 3 is a diagram showing recording information that is registered at the time of recording;

FIG. 4 is a flow chart for explaining a public data creating process;

FIG. 5 is a flow chart for explaining an editing information acquiring process that is executed by a processor of a computer;

FIG. 6 is a flow chart for explaining a search information displaying process;

FIG. 7 is a flow chart for explaining a first modification of a search process; and

FIG. 8 is a flow chart for explaining a second modification of the search process.

### DESCRIPTION OF THE PREFERRED EMBODIMENTS

A description will be given of embodiments of an edited contents reproducing method, an edited contents reproducing apparatus and a computer-readable storage medium according to the present invention, by referring to the drawings.

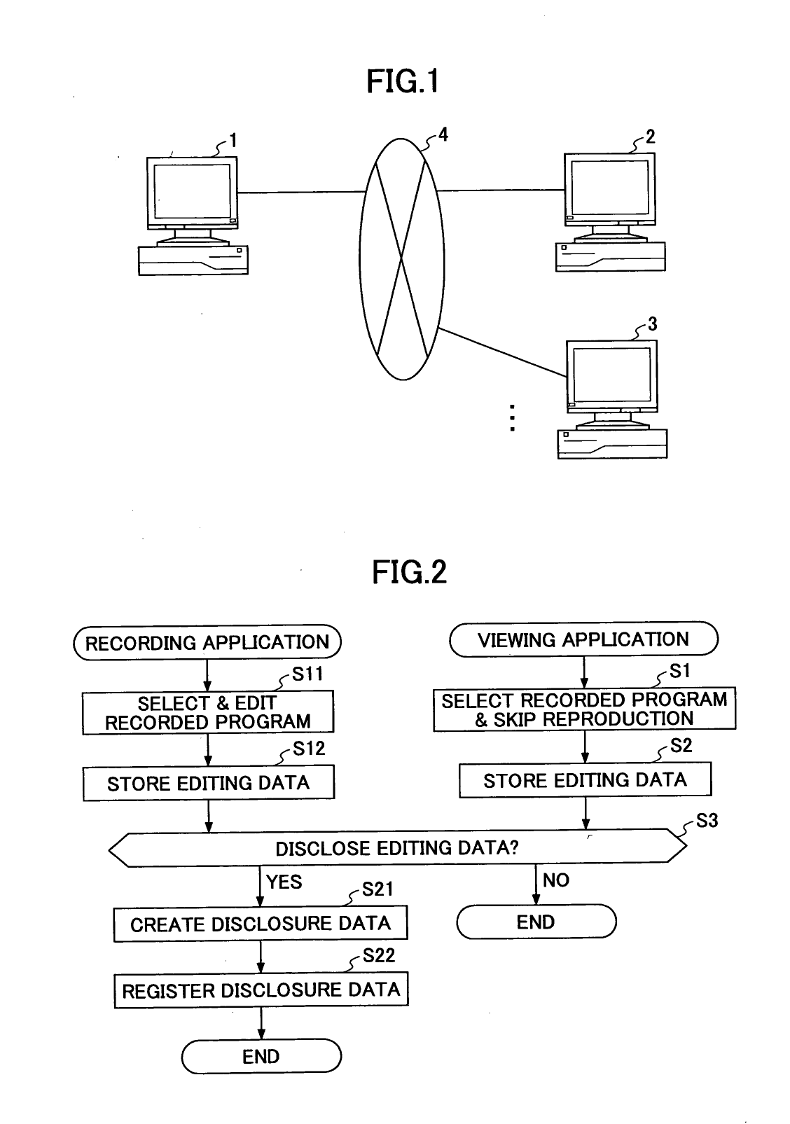

FIG. 1 is a diagram showing a system to which the present invention may be applied. A computer system shown in FIG. 1 include a plurality of computers 1, 2, 3, . . . that are connectable via a network 4. Each of the computers 1, 2, 3, . . . is made up of a personal computer having a known structure that includes a processor such as a CPU, a storage part such as a memory, an input part such as a keyboard, and a display part. The network 4 is made up of a cable and/or wireless network.

It is assumed for the sake of convenience that the computer 1 is installed with one or more applications for realizing a function of receiving a program, a function of storing contents of the program in the storage part thereof, a function of editing the contents of the program, a function of storing editing information that indicates edited parts or edited positions of the edited contents in the storage part thereof, and a function of reproducing the contents or the edited contents and displaying the reproduced contents or reproduced edited contents on the display part thereof. In addition, it is assumed for the sake of convenience that the computer 3 is installed with one or more applications for realizing a function of receiving a program, a function of storing contents of the program in the storage part thereof, a function of accessing editing information of desired contents stored in the storage part of another computer such as the computer 1 and storing the accessed editing information of the desired contents, and a function of reproducing the contents or the desired contents that are edited based on the accessed editing information and displaying the reproduced contents or reproduced edited desired contents on the display part thereof. The one or more applications installed in the computer 3 may further realize a function of editing the contents or the edited contents and storing editing information that indicates edited parts or edited positions of the edited contents in the storage part thereof, and may further realize the so-called Electronic Program Guide (EPG). Of course, each computer that is connectable to the network 4 may be installed with one or more applications that realize both the functions of the computer 1 and the computer 2.

However, the computer 2, for example, may be used as a shared server. In this case, the contents that are edited in each of the computers including the computer 1 may be automatically stored in the storage part of the computer 2 by a known method. In this case, each of the computers including the computer 3 may acquire the editing information of the desired contents by accessing the computer 2.

An embodiment of the edited contents reproducing method according to the present invention and an embodiment of the edited contents reproducing apparatus according to the present invention may be realized by one computer that is connected to the network 4 described above. In addition, an embodiment of the computer-readable storage medium according to the present invention stores a program that is executed by the processor within one computer that is connected to the network 4 described above. In this embodiment, it is assumed for the sake of convenience that a “program” refers to a television program of a television broadcast, but the “program” is of course not limited to the television program of the television broadcast. For example, the “program” may be any of the various kinds of programs that are provided by a cable television system and the Internet.

FIG. 2 is a flow chart for explaining an editing information creating process. A recording application is started when editing the program, and a viewing application is started when reproducing the program. The viewing application includes a function of realizing a skip reproduction.

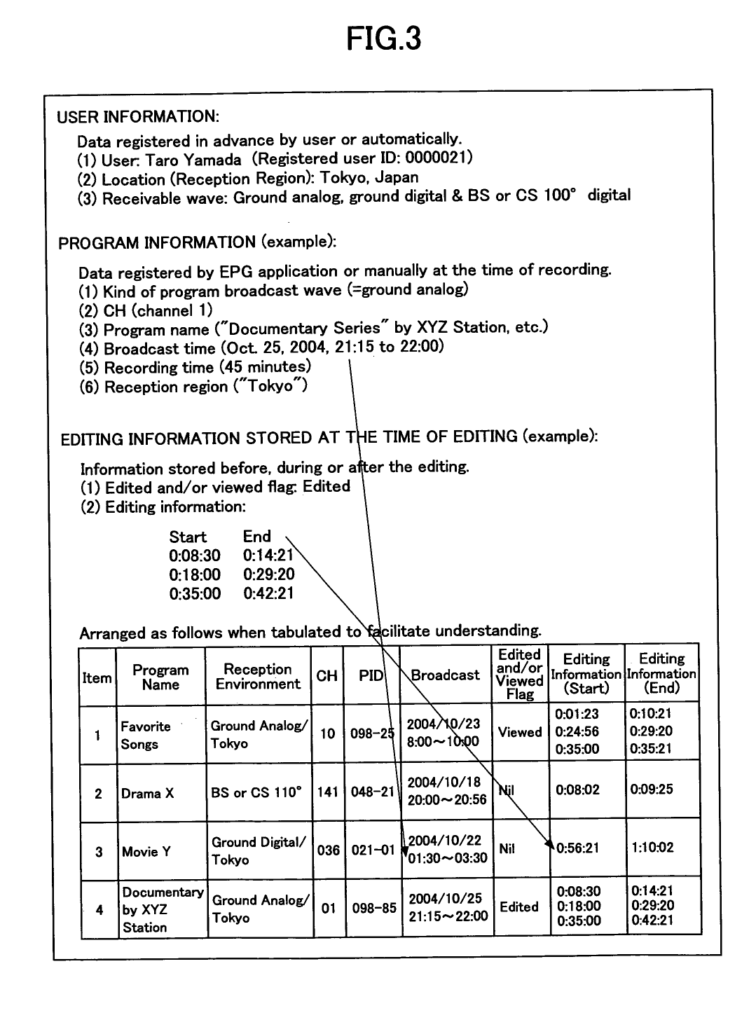

It is assumed for the sake of convenience that the contents of a program is already recorded by a known method and stored in the storage part of the computer 1. FIG. 3 is a diagram showing recording information that is registered at the time of recording the contents of the program. The recording information includes user information, program information and editing information. The user information includes a user name of an editor, and a reception environment that includes the kind of receivable program broadcast wave and the reception region (or reception area). The user information may be registered manually in advance by the user from the input part of the computer 1 or, automatically registered in the computer 1. The program information includes a program name, a reception environment that includes the kind of program broadcast wave and the reception region (or reception area), a channel number (CH), a program identifier (PID), a broadcast time and a recording time. The program information is registered by the EPG application or registered manually by the user, at the time of the recording. The editing information includes status information (or flag) that indicates whether or not the contents of the recorded program are edited and/or whether or not the program has been viewed, and editing data that indicates an edit start position and an edit end position as the edited positions or edited parts of the recorded program.

At the time of the editing, of the recording information described above, at least the status information (or flag) that indicates whether or not the contents of the recorded program are edited and/or whether or not the program has been viewed, and the editing data that indicates the edit start position and the edit end position as the edited positions or edited parts of the recorded program, are updated and stored in the storage part of the computer 1 as the editing information. It is possible to include the user information in the editing information. When the user information is included in the editing information, it is possible to perform a search using the user information as a key, and to perform a search using the editing data and the user information as keys, when carrying out an editing information acquiring process which will be described later, in addition to performing a search of the editing information using the editing data as a key.

In FIG. 2, when the viewing application is started in response to an input from the input part of the computer 1, a step S1 selects a recorded program in response to an input from the input part of the computer 1, and detects whether or not a skip reproduction is to be performed. For example, the skip reproduction reproduces the program by skipping commercial portions of the program. For example, the recorded program may be selected by displaying on the display part of the computer 1 a list of recorded programs stored in the storage part of the computer 1, so as to urge the user to select a desired program from the list, and selecting the desired program selected by the user from the input part of the computer 1. Whether or not to perform the skip reproduction may be selected by displaying on the display part of the computer 1 one or more buttons for selecting whether or not to carry out the skip reproduction, so as to urge the user to select whether or not to carry out the skip reproduction by selecting the appropriate button, and selecting not to carry out the skip reproduction or to carry out the skip reproduction based on the selected button selected by the user from the input part of the computer 1. If the skip reproduction is selected, a step S2 regards as the editing data the editing positions or the editing parts of the program contents, namely, a reproduction start position and a reproduction end position (end position and a start position of the commercial), and updates the editing information by storing, as the editing information, the editing data and the status information in the storage part of the computer 1. A step S3 decides whether or not to disclose (or open) the editing information. For example, whether or not to disclose the editing information may be selected by displaying on the display part of the computer 1 one or more buttons for selecting whether or not to disclose the editing information, so as to urge the user to select whether or not to disclose the editing information by selecting the appropriate button, and selecting not to disclose the editing information or to disclose the editing information for each program or for all of the programs based on the selected button selected by the user from the input part of the computer 1. If the decision result in the step S3 is NO, the process ends. On the other hand, if the decision result in the step S3 is YES, the process advances to a step S21 which will be described later.

When the recording application is started in response to an input from the input part of the computer 1, a step S11 selects a recorded program in response to an input from the input part of the computer 1 and detects whether or not the program is to be edited. The selection of the recorded program may be,made similarly to the selection made in the step S1. Whether or not to edit the program may be selected by displaying on the display part of the computer 1 one or more buttons for selecting whether or not to edit the program and a field for specifying the editing positions or editing parts of the program, so as to urge the user to select whether or not to edit the program by selecting the appropriate button and to input the editing positions or editing parts, and selecting not to edit the program or to edit the program based on the selected button selected by the user and the editing positions or editing parts specified from the input part of the computer 1. If the editing of the program is selected, a step S12 regards as the editing data the editing positions or the editing parts of the specified program contents, namely, the edit start position and the edit end position, and updates the editing information by storing, as the editing information, the editing data and the status information in the storage part of the computer 1. The process advances to the step S3 after the step S12.

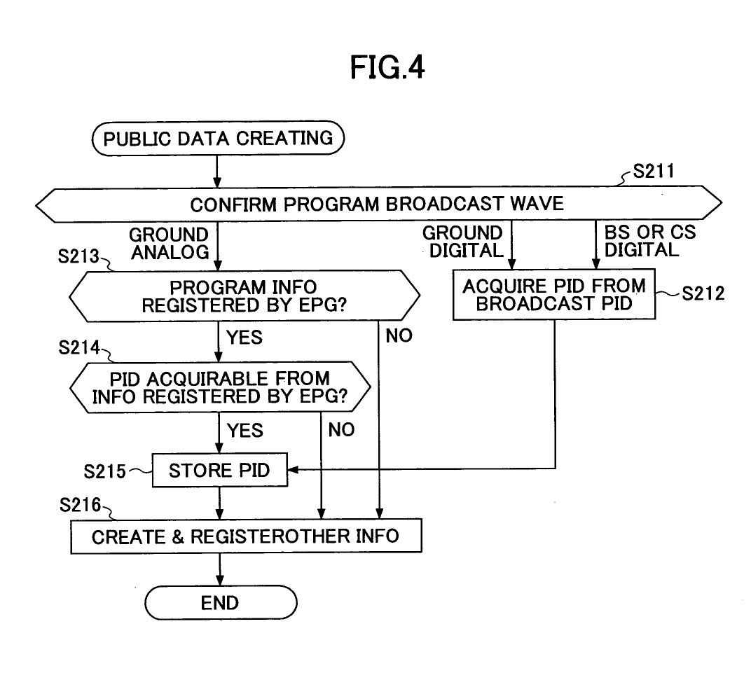

The step S21 creates disclosure data (or public data) for disclosing the editing information. FIG. 4 is a flow chart for explaining a public data creating process. In FIG. 4, a step S11 confirms the program broadcast wave from the recording information, and judges whether the program broadcast wave is a ground analog broadcast, a ground digital broadcast or a broadcast satellite (BS) or a communication satellite (CS) digital broadcast. If the program broadcast wave is the ground digital broadcast or the BS or CS digital broadcast, the process advances to a step S212. The step S212 acquires the PID from a broadcast PID, and the process advances to a step S215 which will be described later. On the other hand, if the program broadcast wave is the ground analog broadcast, the process advances to a step S213. The step S213 decides whether or not the program information registered by the EPG application exists. If the decision result in the step S213 is NO, the process advances to a step S216 which will be described later. If the decision result in the step S213 is YES, a step S214 decides whether or not the PID can be acquired from the program information that is registered by the EPG application.

After the step S212 or if the decision result in the step S214 is YES, the step S215 stores the PID in the storage part of the computer 1, as a portion of the disclosure data. If the decision result in the step S213 or S214 is NO, the step S216 acquires from the recording information other information forming the disclosure data, and stores the other information in the storage part of the computer 1. After the step S216, the process returns to a step S22 shown in FIG. 2.

Returning now to the description of FIG. 2, the step S22 stores the created disclosure data in the storage part of the computer 1, in a manner such that the editing information is accessible from the other computers 2, 3, . . . by searching the disclosure data, and the process ends. In the case where the computer 2 is used as the shared server, the step S22 sends and registers the created disclosure data to the computer 2, and stores the created disclosure data in the storage part of the computer 2, in a manner such that the editing information is accessible from the other computers 1, 3, . . . by searching the disclosure data.

In a case where a mode for automatically disclosing the editing information with respect to all programs is set, the decision result in the step S3 is always YES, and the disclosure data is automatically created and registered.

FIG. 5 is a flow chart for explaining the editing information acquiring process that is executed by the processor of the computer 3. In FIG. 5, a step S31 selects a desired recorded program that is to be viewed and/or edited, based on an input that is made by the user from the input part of the computer 3. For example, the desired recorded program that is to be viewed and/or edited may be selected by displaying on the display part of the computer 3 a list of recorded programs stored in the storage part of the computer 3, so as to urge the user to select the desired recorded program from the list, and selecting the desired recorded program selected by the user from the input part of the computer 1. The desired recorded program may be selected by selecting the PID and/or the program name.

A step S32 selects the editing information of the desired recorded program. The editing information may be selected from the list of the recorded programs described above or, by inputting from the input part of the computer 3 the user information of the desired editor, that is, the user who edited the program contents and disclosed the edited program contents, and/or, the status information (or flag) that indicates whether or not the contents of the recorded program are edited and/or whether or not the recorded program has been viewed.

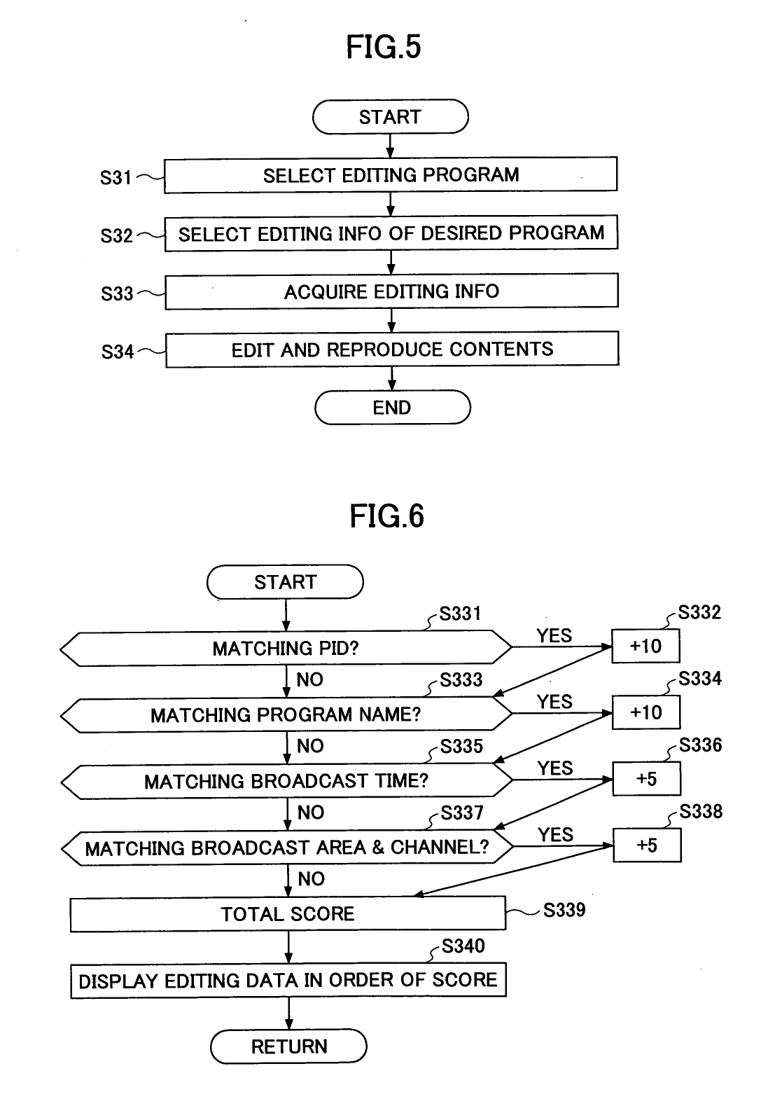

A step S33 searches the disclosure data within the computers 1, 2, . . . that are connected to the network 4 using the desired recorded program that is selected and the editing information thereof as keys, by a known method, and acquires the editing data of the corresponding editing information from the computer to which the search hits. If the desired editor is fixed and is the user of the computer 1, for example, it is possible to access, for the search, only the computer 1 based on the user information of the desired editor. In addition, in the case where the computer 2 is used as the shared server, it is possible to always access, for the search, only the computer 2 that centrally manages the disclosure data of all users. Moreover, in a case where a plurality of editing data are acquired, the editing data desired by the user of the computer 3 may be selected, as will be described later in conjunction with FIG. 6.

A step S34 stores the acquired editing data in the storage part of the computer 3, as the editing information, and reproduces the contents of the desired program based on the editing data, so as to display the reproduced program contents on the display part of the computer 3. The process ends after the step S34. Of course, the step S34 may store in the storage part of the computer 3 the edited program contents of the reproduced desired program.

Therefore, the user of the computer 3 does not need to edit the contents of the desired program himself, and can automatically acquire the editing data related to the edited contents of the desired program from the disclosed editing data. The contents of the desired program may be edited and reproduced based on the acquired editing data. In addition, since the editing data is acquired via the network 4, and the program contents or the actually edited program contents are not transferred via the network 4, it is possible reduce the load on the network 4.

FIG. 6 is a flow chart for explaining a search information displaying process of the step S33. In FIG. 6, a step S331 searches the disclosure data within the computers 1, 2, . . . that are connected to the network 4 using as a key the PID, of the selected desired program and the editing information thereof, by a known method, and decides whether or not there exists a disclosure data having a matching PID. If the decision result in the step S331 is YES, a step S332 adds +10 points to a score indicating the likelihood (or probability or accuracy) of including the desired editing data, with respect to the disclosure data having the matching PID.

If the decision result in the step S331 is NO or after the step S332, a step S333 performs a search similar to the above using as a key the program name, of the selected desired program and the editing information thereof, and decides whether or not there exists a disclosure data having a matching program name. If the decision result in the step S333 is YES, a step S334 adds +10 points to a score indicating the likelihood (or probability or accuracy) of including the desired editing data, with respect to the disclosure data having the matching program name. The number of points that are added to the score in the step S334 may be made variable depending on the degree of matching of the characters, numerals and/or symbols included in the program name.

If the decision result in the step S333 is NO or after the step S334, a step S335 performs a search similar to the above using as a key the broadcast time, of the selected desired program and the editing information thereof, and decides whether or not there exists a disclosure data having a matching broadcast time. If the decision result in the step S335 is YES, a step S336 adds +5 points to a score indicating the likelihood (or probability or accuracy) of including the desired editing data, with respect to the disclosure data having the matching broadcast time. The broadcast times may be regarded as a match if a difference between the broadcast start times and a difference between the program lengths are both within 5 minutes, for example.

If the decision result in the step S335 is NO or after the step S336, a step S337 performs a search similar to the above using as keys the reception environment (for example, reception region or reception area) and the channel, of the selected desired program and the editing information thereof, and decides whether or not there exists a disclosure data having a matching reception environment and a matching channel. If the decision result in the step S337 is YES, a step S338 adds +5 points to a score indicating the likelihood (or probability or accuracy) of including the desired editing data, with respect to the disclosure data having the matching reception environment and the matching channel.

If the decision result in the step S337 is NO or after the step S338, a step S339 adds the scores to obtain a total score for each of the disclosure data. A step S340 displays on the display part of the computer 3 the editing data acquired from the hit disclosure data, in an order starting from the highest total score, for example, so as to urge the user of the computer 3 to select the desired editing data. It is possible to display on the display part only the editing data having the total scores exceeding a predetermined value. The user of the computer 3 may confirm the contents of the editing data on the display part, and select the desired data from the input part. Of course, the editing data having the highest score may be selected automatically.

Furthermore, the score may be recorded in the disclosure data at the source of each of the editing data. In this case, the user of the computer 3 can perform the search using also the score having a predetermined value as the key, so as to acquire only the editing data having the scores exceeding the predetermined value, that is, the editing data having a high frequency of use. As a result, the search can further be narrowed.

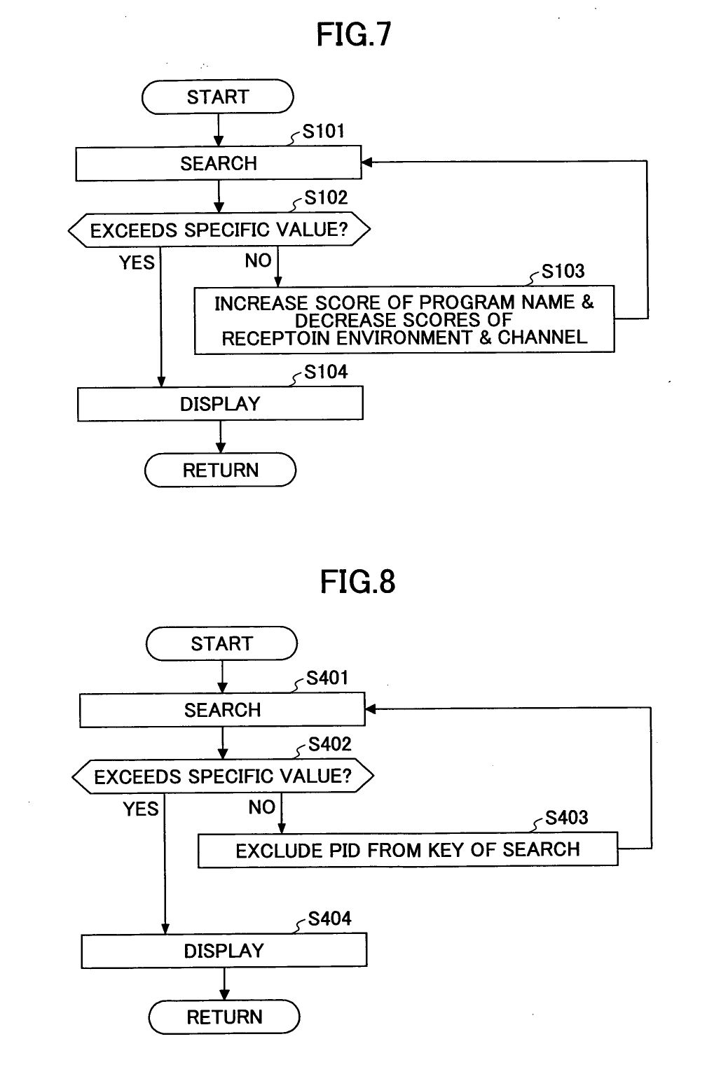

FIG. 7 is a flow chart for explaining a first modification of the search process of the step S33. In this modification, the user of the computer 3 performs the search using also the score having the predetermined value as the key, so as to acquire only the editing data having the scores exceeding the predetermined value, that is, the editing data having a high frequency of use. In FIG. 7, a step S101 acquires the editing data from the disclosure data having the score exceeding the predetermined value. A step S102 decides whether or not the number of acquired editing data exceeds a specific value. If the decision result in the step S102 is NO, a step S103 increases the value that is to be added to the score of the disclosure data having the matching program name, and decreases the value that is to be added to the score of the disclosure data having the matching reception environment (for example, reception region or reception area) and the matching channel. The process returns to the step S101 after the step S103. On the other hand, if the decision result in the step S102 is YES, a step S104 displays the acquired editing data on the display part of the computer 3.

Accordingly, the search condition is relaxed (or relieved) if the number of acquirable editing data is small, so that the editing data may be acquired from the disclosure data related to a wider reception region or reception area.

FIG. 8 is a flow chart for explaining a second modification of the search process of the step S33. In this modification, the user of the computer 3 performs the search using also the score having the predetermined value as the key, so as to acquire only the editing data having the scores exceeding the predetermined value, that is, the editing data having a high frequency of use. In FIG. 8, a step S401 acquires the editing data from the disclosure data having the score exceeding the predetermined value. A step S402 decides whether or not the number of acquired editing data exceeds a specific value. If the decision result in the step S402 is NO, a step S403 excludes the PID from the key of the search, and the process returns to the step S401. On the other hand, if the decision result in the step S402 is YES, a step S404 displays the acquired editing data on the display part of the computer 3.

In a case where the number of users providing the disclosure data related to the digital broadcast, the search using the PID as the key will naturally result in a small number of acquirable editing data. However, if the same program is broadcast in both the digital broadcast and the analog broadcast, it is possible to acquire the editing data with respect to the program of the analog broadcast as a substitute. Hence, in this modification, the PID is excluded from the key of the search if the number of acquired editing data is less than or equal to the specific value, so as to relax (or relieve) the search condition, so that the editing data may be acquired from a larger number of disclosure data.

In the embodiment described above, the present invention is applied to a computer system. However, the present invention is applicable to apparatuses other than the personal computer, as long as the apparatuses are provided with the parts or means for realizing the functions described above. For example, the present invention is similarly applicable to a HDD drive, a DVD drive and the like. In addition, the present invention is also similarly applicable to various kinds of portable apparatuses such as a PDA and a portable telephone, that are provided with the parts or means for realizing the functions described above.

Therefore, the present invention is suited for application to an apparatus that reproduces desired edited contents by accessing another apparatus.

This application claims the benefit of a Japanese Patent Application No. 2005-092996 filed Mar. 28 2005, in the Japanese Patent Office, the disclosure of which is hereby incorporated by reference.

Further, the present invention is not limited to these embodiments, but various variations and modifications may be made without departing from the scope of the present invention.

What is claimed is:

1. An edited contents reproducing method comprising:
(a) accessing, from a first apparatus storing desired program contents, via a network, editing information indicating edited parts of the desired program contents stored in a second apparatus that is other than the first apparatus, based on user information related to an editor and/or program information; and
(b) reproducing, in the first apparatus, the desired program contents in an edited state based on the editing information that is accessed.

2. The edited contents reproducing method as claimed in claim 1, wherein the second apparatus is formed by an apparatus that edited the desired program contents.

3. The edited contents reproducing method as claimed in claim 1, wherein the second apparatus is formed by a shared server that is different from a third apparatus that edited the desired program contents.

4. The edited contents reproducing method as claimed in claim 1, wherein the user information includes a user name, and a reception environment, said reception environment including a kind of receivable program broadcast wave and a reception region or area.

5. The edited contents reproducing method as claimed in claim 1, wherein the program information includes a program name, a reception environment, a channel number, a program identifier, a broadcast time and a recording time.

6. The edited contents reproducing method as claimed in claim 1, wherein the editing information includes status information that indicates whether or not the recorded program contents are edited and/or whether or not the recorded program contents have been viewed.

7. The edited contents reproducing method as claimed in claim 1, further comprising the steps of:
(c) editing the desired program contents stored in the first apparatus, in the edited state.

8. The edited contents reproducing method as claimed in claim 1, wherein said step (a) selects desired editing information from editing information output from the second apparatus in an order depending on a degree of matching of the user information and the program information.

9. An edited contents reproducing apparatus comprising:
a storage part configured to store desired program contents;
an access part configured to access, via a network, editing information indicating edited parts of the desired program contents stored in an external apparatus, based on user information related to an editor and/or program information; and
a reproducing part configured to reproduce the desired program contents in an edited state based on the editing information that is accessed.

10. The edited contents reproducing apparatus as claimed in claim 9, wherein the user information includes a user name, and a reception environment, said reception environment including a kind of receivable program broadcast wave and a reception region or area.

11. The edited contents reproducing apparatus as claimed in claim 9, wherein the program information includes a program name, a reception environment, a channel number, a program identifier, a broadcast time and a recording time.

12. The edited contents reproducing apparatus as claimed in claim 9, wherein the editing information includes status information that indicates whether or not the recorded program contents are edited and/or whether or not the recorded program contents have been viewed.

13. The edited contents reproducing apparatus as claimed in claim 9, further comprising:
an editing part configured to edit the desired program contents stored in the storage part, in the edited state.

14. The edited contents reproducing apparatus as claimed in claim 9, wherein said access part selects desired editing information from editing information output from the external apparatus in an order depending on a degree of matching of the user information and the program information.

15. A computer-readable storage medium which stores a program for causing a computer that stores desired program contents in a storage part to access editing data, said program comprising:
an accessing procedure causing the computer to access, via a network, editing information indicating edited parts of the desired program contents stored in an external apparatus, based on user information related to an editor and/or program information; and
a reproducing procedure causing the computer to reproduce the desired program contents in an edited state based on the editing information that is accessed.

16. The computer-readable storage medium as claimed in claim 15, wherein said program further comprises:
an editing procedure causing the computer to edit the desired program contents stored in the storage part, in the edited state.
